(19) United States
(12) Patent Application Publication
(10) Pub. No.: US 2025/0246332 A1
(43) Pub. Date: Jul. 31, 2025

(54) RADIONUCLIDE PRODUCTION SYSTEM AND RADIONUCLIDE PRODUCTION METHOD

(71) Applicant: HITACHI HIGH-TECH CORPORATION, Tokyo (JP)

(72) Inventors: Yuichiro UENO, Tokyo (JP); Takahiro TADOKORO, Tokyo (JP); Mizuho MAEDA, Tokyo (JP); Takahiro WATANABE, Tokyo (JP); Takahiro SASAKI, Tokyo (JP)

(21) Appl. No.: 18/855,348

(22) PCT Filed: Aug. 2, 2023
(86) PCT No.: PCT/JP2023/028331

§ 371 Date: Oct. 9, 2024

(30) Foreign Application Priority Data
Sep. 14, 2022 (JP) 2022-146591

(51) Int. Cl. G21G 1/00; G21G 1/10

(52) U.S. Cl. CPC G21G 1/001; G21G 1/10; G21G 2001/0089

(57) ABSTRACT

The present invention provides a radionuclide production system and a radionuclide production method with which it is possible to produce radionuclides efficiently by improving the cooling of a target material containing a raw material nuclide and reducing contamination of the target material with impurities. A radionuclide production system comprises a particle beam irradiation device that generates a particle beam, and a target that generates radionuclides through irradiation with the particle beam. In the target, a target material containing a raw material nuclide that generates radionuclides is mounted on a target cooling plate for cooling the target material. The radionuclide production method comprises: forming a target in which a target material containing a raw material nuclide is mounted on a target cooling plate for cooling the target material; and producing radionuclides by irradiating the target with a particle beam or bremsstrahlung radiation while cooling the target material using the target cooling plate.

### TECHNICAL FIELD

The present invention relates to a radionuclide production system and a radionuclide production method using a target that generates radionuclides by irradiation of particle beams.

### BACKGROUND ART

Traditionally, radionuclides have been used in nuclear medicine diagnostics such as positron emission tomography (PET) and single photon emission computed tomography (SPECT). However, in recent years, RI internal therapy, which uses radionuclides for direct treatment rather than as just markers, has attracted attention.

RI internal therapy is a method of administering a drug that incorporates radionuclides and irradiating an affected tissue directly with radiation. Drugs are administered that have the property of selectively accumulating in the target affected tissue. Treatment of thyroid cancer, Basedow's disease, and the like is carried out by RI internal therapy.

Conventional RI internal therapy uses β-ray sources, and thyroid cancer treatment with I-131 has been practiced since the 1940s. On the other hand, in recent years, RI internal therapy using α-ray sources with short flight range and high linear energy transfer has attracted attention due to high therapeutic effect.

Examples of α-ray emission nuclides used in RI internal therapy include actinium 225 (Ac-225), radium 223 (Ra-223), astatine 211 (At-211), and the like. In particular, Ac-225 produces α-ray emitting nuclides by radioactive decay. Since daughter nuclides and progeny nuclides also emit α-rays, such nuclides can obtain a high therapeutic effect.

Traditionally, actinium 225 (Ac-225) has been produced by decay from thorium 229 (Th-229). Th-229 is not in nature and has been generated by decay from uranium 233 (U-233). However, due to concerns about the shortage of supply due to nuclear material protection, mass production using accelerators is being considered.

Within the limitations of cooling the heat load by the particle beam, PTL 1 describes a radionuclide production apparatus for efficiently producing a desired radionuclide with less target material. The apparatus includes a plurality of target material plates arranged to be overlapped with each other for generating radionuclides. A target device loaded with the target material plate is cooled by cooling water supplied in a circulating manner.

### CITATION LIST

### Patent Literature

PTL 1: JP2017-156143A

### SUMMARY OF INVENTION

### Technical Problem

In a system that produces radionuclides, for a target that generates radionuclides by irradiation of particle beams, it is required to efficiently remove heat load due to irradiation of particle beams. However, in PTL 1, only the selected raw material is used to form the target material plate. The target material plate consisting of the raw material is loaded inside the target device. The target device loaded with the target material plate is cooled with cooling water.

In PTL 1, only the raw material is used to form the target material plate, and there is a problem that the thermal conductivity of the raw material and the moldability of the raw material are not considered. When the thermal conductivity of the raw material is low, it is difficult to efficiently remove heat load on the target material plate. Depending on the type of raw material, it may be difficult to form the target material plate. In the method of forming the target material plate using only the raw material, there are major constraints in the design of the device and the selection of the raw material.

In the method of forming the target material plate using only the raw material, there is a problem that impurity contamination occurs because the raw material is exposed to the outside. When irradiating particle beams, external impurity nuclides may be mixed into the target material plate. When the target material plate generates contamination, it is costly and troublesome to separate and purify the desired radionuclide from the target material plate.

Accordingly, an object of the present invention is to provide a radionuclide production system and a radionuclide production method that can efficiently produce radionuclides by improving a cooling ability of a target raw material containing a raw material nuclide and reducing contamination of impurities to the target raw material.

### Solution to Problem

To solve the problem, in a radionuclide production system according to the present invention, the radionuclide production system that generates radionuclides includes a particle beam irradiation device that generates particle beams and target that generates radionuclides by irradiation of the particle beams, in which in the target, a target raw material containing a raw material nuclide that generates the radionuclide is implemented on a target cooling plate that cools the target raw material.

The radionuclide production method according to the present invention forms a target in which a target raw material containing a raw material nuclide that generates radionuclides by irradiation of particle beams is implemented on a target cooling plate that cools the target raw material, and produces radionuclides by irradiating the target with particle beams or bremsstrahlung while cooling the target raw material by the target cooling plate.

### Advantageous Effects of Invention

According to the present invention, a radionuclide production system and a radionuclide production method can be provided that can efficiently produce radionuclides by improving a cooling ability of a target raw material containing a raw material nuclide and reducing contamination of impurities to the target raw material.

### BRIEF DESCRIPTION OF DRAWINGS

FIG. 1 is a diagram illustrating a configuration example of a radionuclide production system according to a first embodiment.

FIG. 2 is a diagram illustrating a configuration example of a radionuclide production system according to a second embodiment.

FIG. 3 is a diagram illustrating a configuration example of a radionuclide production system according to a third embodiment.

FIG. 4 is a diagram illustrating a configuration example of a radionuclide production system according to a fourth embodiment.

### DESCRIPTION OF EMBODIMENTS

Hereinafter, a radionuclide production system and a radionuclide production method according to an embodiment of the present invention will be described with reference to the drawings. In the following drawings, the same reference numerals will be given for common configurations and duplicate descriptions will be omitted.

### First Embodiment

FIG. 1 is a diagram illustrating a configuration example of a radionuclide production system according to a first embodiment.

As illustrated in FIG. 1, a radionuclide production system 1 according to the first embodiment includes a particle beam irradiation device 10 that generates particle beams and a target 20 that generates radionuclides by irradiation of particle beams. The target 20 includes a target raw material 21 containing a raw material nuclide that generates radionuclides and a target cooling plate 22 that cools the target raw material 21.

The radionuclide production system 1 is a device that generates a predetermined radionuclide by nuclear transformation of a raw material nuclide by a nuclear reaction. The nuclear reaction is caused by irradiating the raw material nuclide contained in the target raw material 21 with a particle beam 11 or bremsstrahlung. The particle beam 11 or bremsstrahlung having energy equal to or greater than a threshold required for a nuclear reaction are generated by the particle beam irradiation device 10.

The radionuclide production process in a radionuclide production system is performed in the following manner. A suitable target raw material 21 containing a raw material nuclide is implemented on the target cooling plate 22 to form the target 20. Then, the target 20 is placed in an irradiation field and an irradiation process is performed. The irradiation process is a treatment that causes a nuclear reaction in the raw material nuclide by irradiation of the particle beam 11 or the bremsstrahlung.

In the irradiation process, radionuclides are produced by irradiating the target 20 with the particle beam 11 or the bremsstrahlung while cooling the target raw material 21 by the target cooling plate 22. When the irradiation process is performed, a nuclear reaction of the raw material nuclide occurs by the particle beam 11 or the bremsstrahlung, and the raw material nuclide is nuclear transformed to generate a predetermined generated nuclide. Subsequently, the target 20 subjected to the irradiation process is transported from the irradiation field to a separation and refinement field to be subjected to a separation and refinement process. The separation and refinement process is a process for separating and refining the generated nuclide, which was generated from the raw material nuclide, from the raw material nuclide and the like by irradiation of the particle beam 11 or the bremsstrahlung.

In the separation and refinement process, the desired radionuclide is recovered as an appropriate chemical form from a chemical species containing the raw material nuclide or the generated nuclide held on the target 20. The radionuclide to be recovered may be a daughter nuclide generated by a nuclear reaction of the raw material nuclide, or a progeny nuclide generated by radioactive decay of the daughter nuclide after the nuclear reaction of the raw material nuclide.

When the particle beam 11 is used to induce a nuclear reaction, the particle beam 11 generated by the particle beam irradiation device 10 is irradiated to the raw material nuclide contained in the target raw material 21. When the bremsstrahlung is used to induce a nuclear reaction, the particle beam 11 generated by the particle beam irradiation device 10 is irradiated to a converter that generates the bremsstrahlung, and the bremsstrahlung emitted by the converter is irradiated to the raw material nuclide contained in the target raw material 21.

Heavy metals having a large atomic number and density can be used as the converter. Specific examples of the converter include platinum (Pt), tungsten (W), tantalum (Ta), lead (Pb), bismuth (Bi), and the like. The converter may be disposed outside the target 20 or may be disposed inside the target 20. The converter can be disposed separately with respect to the target 20 or can be disposed integrally with the target 20.

The function as the converter can also be combined with the target raw material 21 and the target cooling plate 22. For example, the heavy metal that functions as the converter can be used as the raw material nuclide contained in the target raw material 21 or as the material nuclide that forms the target cooling plate 22. The particle beam 11 generated by the particle beam irradiation device 10 can also be irradiated to such nuclides to generate the bremsstrahlung on the target raw material 21 and the target cooling plate 22.

In FIG. 1, the target 20 includes the target raw material 21 on the incident side of the particle beam 11 and the target cooling plate 22 on the opposite side. However, the target 20 may include the target cooling plate 22 on the incident side of the particle beam 11 and the target raw material 21 on the opposite side. In such an arrangement, the particle beam 11 can be incident on the target cooling plate 22, which also serves as the converter, and the bremsstrahlung emitted from the target cooling plate 22 can be irradiated to the target raw material 21 in the rear side.

The target raw material 21 can be formed of a raw material in a suitable chemical form containing a raw material nuclide. Suitable nuclides can be used as raw material nuclides depending on the radionuclide to be produced. Specific examples of the raw material nuclide include radium-226 (Ra-226), molybdenum-100 (Mo-100), zinc-68 (Zn-68), hafnium-178 (Hf-178), germanium-70 (Ge-70), and the like.

Suitable nuclear reactions such as photonuclear reactions such as (γ, n), (γ, p), (γ, 2n), and (γ, pn) by the bremsstrahlung and nuclear reactions by particle beams such as charged particle beams and heavy particle beams can be used as nuclear reactions to nuclear transform raw material nuclides depending on the radionuclide to be produced, the type of the raw material nuclide, the required energy, and the like.

The radionuclides produced by the radionuclide production system 1 are not particularly limited. As a radionuclide, α-ray emitting nuclides are particularly preferred in terms of usefulness as therapeutic agents used in RI internal therapy.

As the particle beam irradiation device 10, a device including a charged particle source that generates charged particles such as electrons and an accelerator that accelerates the charged particles is preferable in that a high-energy particle beam 11 can be generated. Suitable devices such as linear accelerators such as high-frequency quadrupole linear accelerator, circular accelerators such as cyclotrons and synchrotrons, and combinations thereof can be used as accelerators depending on the type of radionuclide to be produced, the type of raw material nuclide, and the nuclear reaction to be used.

As the particle beam irradiation device 10, when irradiating an electron beam as the particle beam 11, it is preferable to use an electron linear accelerator. With the electron linear accelerator, high-energy electron beams can be generated by a small device. When the electron beam is irradiated to the converter, the bremsstrahlung required for the photonuclear reaction can be generated with a high probability.

For example, when producing actinium-225 (Ac-225), which is an x-ray emitting nuclide, an Ra-226 (γ, n) Ra-225 reaction by irradiation with the bremsstrahlung and β decay of Ra-225 can be utilized. As the target raw material 21 containing the raw material nuclide, radium chloride (RaCl₂) containing Ra-226 can be used.

Radium 226 (Ra-226) used as the raw material nuclide can also serve as the converter. When the electron beam irradiated from the electron linear accelerator is incident on the target raw material 21 containing Ra-226, the bremsstrahlung is emitted by the bremsstrahlung of Ra-226. The bremsstrahlung is irradiated to the surrounding Ra-226 contained in the target raw material 21.

Ra-226 undergoes a photonuclear reaction of Ra-226 (γ, n) Ra-225 when irradiated with the bremsstrahlung, releasing neutrons to be nuclear transformed to Ra-225. Ra-225 undergoes β decay with a half-life of 14.9 days, resulting in Ac-225. Ac-225 is an x-ray emitting nuclide useful as a raw material for therapeutic agents.

Ac-225 becomes Fr-221 with a half-life of 10.0 days. Fr-221 has a half-life of 4.9 minutes, resulting in At-217. At-217 has a half-life of 32 milliseconds, resulting in Bi-213. The progeny nuclides are also α-ray emitting nuclides and can be used as raw materials for therapeutic agents. Ac-225 and progeny nuclide thereof can be recovered by subjecting the target raw material 21 to a separation and refinement process after irradiation.

Since Ra-226 and Ra-225 are not α-ray emitting nuclides, Ra-226 and Ra-225 are unnecessary as raw materials for therapeutic agents. It is preferable that remaining Ra-226 and Ra-225 after the irradiation process be separated from α-ray emitting nuclides such as Ac-225. Since Ra-226 is relatively expensive, it is preferable to reuse Ra-226 as a raw material nuclide. Ra-226 separated from the unreacted raw material nuclide can be reimplemented to the target cooling plate 22.

As illustrated in FIG. 1, in the radionuclide production system 1, as the target 20 for generating radionuclides, a target device in which the target raw material 21 is implemented on the target cooling plate 22 is used. As used herein, implementation means that one component is incorporated into other components such that the function of each component can be achieved.

When the target raw material 21 is implemented on the target cooling plate 22, it is possible to generate radionuclides by the target raw material 21 and cool the target raw material 21 by the target cooling plate 22. In other words, the target raw material 21 containing the raw material nuclide that generates radionuclides is positionally fixed relative to the target cooling plate 22 while heat transfer properties for removing heat load are ensured.

The target raw material 21 and the target cooling plate 22 do not necessarily need to be in contact with each other. The target raw material 21 and the target cooling plate 22 may be in contact with each other or may be spaced apart from each other. As long as heat transfer properties are ensured between the target raw material 21 and the target cooling plate 22, other components and spaces may be interposed. However, it is preferable that the target raw material 21 does not contact with the coolant for cooling the target raw material 21.

A fixing method for positionally fixing the target raw material 21 relative to the target cooling plate 22 is not particularly limited. Suitable methods can be used as the fixing method, such as adhesion of powder or the like, joining by welding, joining using joining parts such as bolts, and the like. However, from the viewpoint of reducing contamination to the target raw material 21, a method that does not use foreign substances such as joining parts is preferred.

Suitable raw materials can be used as the target raw material 21 according to the chemical form of the raw material nuclide, such as powder, powder aggregate, powder compact, bulk, and a processed product of bulk. For example, a raw material solution in which a chemical species containing a raw material nuclide is dissolved can be applied or sprayed on the target cooling plate 22 and a powder can be obtained by evaporating and drying. Aggregates, compacts, bulk, and the like can be obtained by compression molding, sintering, casting, and the like of a chemical species containing a raw material nuclide.

Note that in FIG. 1, the target 20 is disposed in the vertical direction and the particle beam 11 is irradiated from the horizontal direction. However, the target 20 can also be disposed in other directions. The particle beam 11 can also be irradiated from other directions. For example, it is also possible to irradiate the particle beam 11 from above with respect to the target 20 disposed as a lateral direction. Here, the target raw material 21 can be simply placed on the target cooling plate 22.

The target cooling plate 22 can be cooled by an appropriate method such as direct cooling by water cooling, air cooling, and the like, and indirect cooling by heat exchange with a coolant, and the like. A cooling mechanism for conductive cooling or heat exchange may be integrally provided to the target cooling plate 22 or may be attached separately. The target cooling plate 22 may be provided with through holes and grooves as a cooling channel for circulating the coolant, fins to improve cooling efficiency, and the like.

When the target raw material 21 is implemented on the target cooling plate 22, the heat load on the target raw material 21 by irradiation of the particle beam 11 or the like can be removed by the target cooling plate 22. Regardless of thermal conductivity and moldability of the target raw material 21, the target raw material 21 can be cooled efficiently using the target cooling plate 22. Therefore, cooling ability of the target raw material 21 can be improved while ensuring the degree of freedom of selection of the target raw material 21. Contamination of the target raw material 21 by the coolant can be reduced.

For example, since the target raw material 21 can be cooled efficiently without being molded into a shape and thickness suitable for cooling, it is also possible to use a chemical form with low thermal conductivity or a chemical form with low moldability as the target raw material 21. Since the target raw material 21 can be cooled without contact with the coolant, it is also possible to use a chemical form that elutes in the coolant or a chemical form that reacts with the coolant as the target raw material 21. Since the target raw material 21 does not contact with the coolant, incorporation of the components contained in the coolant can be prevented.

Generally, impurity nuclides may occur in the irradiation field that irradiates the target device with particle beams due to particle beams, secondary radiation, and the like. Impurities scattered in the irradiation field can enter and diffuse into the target raw material. If impurities are mixed in the target raw material, when the radionuclide contained in the target raw material is separated and refined after irradiation, it is necessary to separate the impurities, which is costly and troublesome to refine. When the recovered radionuclides are used for pharmaceutical applications, safety, toxicity, and quality become problems due to the incorporation of impurities. In synthesis of drugs or the like, problems such as competitive inhibition by impurity nuclides arise.

On the other hand, when the target raw material 21 is implemented on the target cooling plate 22, contamination of the impurity nuclides present in the irradiation field to the target raw material 21 can be reduced. The target cooling plate 22 acts as a barrier to prevent impurity nuclides from entering the target raw material 21. The impurity nuclides scattered from the direction in which the target cooling plate 22 are disposed toward the target raw material 21 is trapped in the target cooling plate 22. Therefore, the contamination by impurities present in the irradiation field can be reduced, efficient separation and refinement process is possible, and safety and quality of the radionuclide product can be ensured.

The target raw material 21 is preferably implemented on a surface of a main surface of the target cooling plate 22. That is, in a plan view of the target 20, an area of the target raw material 21 is preferably provided to be smaller than an area of the target cooling plate 22. The target raw material 21 is preferably disposed inwardly than a projection line of a contour of the target cooling plate 22. Such area or arrangement can widely reduce contamination of the impurity nuclides present in the irradiation field to the target raw material 21.

The target 20 can be held in the irradiation field in which the irradiation process that irradiates the particle beam 11 is performed, or the separation and refinement field in which the separation and refinement process that separates and refines the radionuclide is performed, by a holding mechanism (not illustrated). The holding mechanism may include a cooling mechanism to cool the target cooling plate 22 to remove heat load on the target raw material 21 by irradiation of the particle beam 11. Depending on the radionuclide to be separated and refined, the separation and refinement field can be provided with a chromatograph, a centrifuge, a sedimentation separator, an evaporation separator, and the like.

The target 20 can also be provided in a container structure that seals the target raw material 21. The container structure includes a structure covering the target raw material 21 with an outer wall material, or a structure covering a part or all of the target raw material 21 and the target cooling plate 22 with an outer wall material. When the target 20 is provided in a container structure that seals the target raw material 21, it is possible to prevent scattering of the target raw material 21 and release of radioactive materials from the target raw material 21. When Ra-226 is used as the raw material nuclide, α decay of Ra-226 results in Rn-222. Since Rn-222 is a rare gas and is easily spread around, it is preferable to seal the target raw material 21.

A transport mechanism that transports the target 20 can be provided in the radionuclide production system 1. The transport mechanism may be a robot arm, a conveyor, or the like. The target 20 subjected to the irradiation process can be transported from the irradiation field to the separation and refinement field by the transport mechanism to be subjected to the separation and refinement process. The target 20 subjected to the separation and refinement process can be transported from the separation and refinement field to the irradiation field by the transport mechanism, and then subjected to the irradiation process after re-implementing the target raw material 21, as necessary.

The target cooling plate 22 can be formed of ceramic, metal, and the like. The target cooling plate 22 can be formed in a suitable material form such as a single crystal, a polycrystal, a sintered body, an amorphous body such as glass, and the like. As long as the target cooling plate 22 has a main surface on which the target raw material 21 can be implemented, the target cooling plate 22 can be provided in a suitable shape such as a rectangular shape or a circular shape, as well as in a suitable structure and size.

The target cooling plate 22 is preferably formed of a material having higher thermal conductivity than the target raw material 21. When formed of such material, the heat load on the target raw material 21 by irradiation of the particle beam 11 or the like can be efficiently removed by the target cooling plate 22. Since the cooling ability of the target raw material 21 is improved, melting of the target raw material 21 and burnout of the target 20 can be prevented.

The target cooling plate 22 is preferably formed of a material having a lower atomic number than the target raw material 21. When formed of such material, the radiation of the target cooling plate 22 can be prevented when the particle beam 11 is irradiated. Since it is difficult for the radionuclides generated by radiation to be mixed with the target cooling plate 22 after irradiation, handling at the time of disposal can be facilitated.

The target cooling plate 22 is preferably formed of a material having a lower transmittance of the particle beam 11 or the bremsstrahlung than the target raw material 21. When formed of such material, the transmittance of the particle beam 11 or the like can be easily ensured, so that the generation efficiency of the radionuclide can be increased.

The target cooling plate 22 is preferably made of silicon, silicon dioxide, silicon carbide, aluminum, aluminum nitride, or diamond. Since such materials have high thermal conductivity, the heat load on the target raw material 21 can be removed with high cooling efficiency. Because the atomic number of such materials is relatively small, it is easy to prevent the radiation of the target cooling plate 22 and ensure the transmittance of the particle beam 11 and the like.

Materials made of silicon include a silicon substrate that is a single crystal, a silicon substrate that is a polycrystal, and the like. Materials made of silicon dioxide include a quartz substrate that is a single crystal, a glass substrate that is an amorphous body, and the like. Materials made of silicon carbide include a silicon carbide substrate that a is single crystal, a polymorphic polycrystal of silicon carbide, a sintered body of silicon carbide, and the like. Materials made of aluminum nitride include an aluminum nitride substrate that is a single crystal, a sintered body of aluminum nitride, and the like.

The thermal conductivity of silicon is about 160 W/mK. The thermal conductivity of silicon dioxide is about 1.5 W/mK. With silicon, a thermal conductivity is obtained higher than that of silicon dioxide that is generally used as a material of the substrate, and a cooling performance equal to or greater than that of metal is obtained. The thermal conductivity of diamond is also about 2000 W/mK. With diamond, since the highest thermal conductivity is obtained among solid materials, a significant improvement in the cooling performance is expected.

The target cooling plate 22 is preferably made of silicon. As a material made of silicon, a high-purity silicon substrate used in the semiconductor field can be used. With the high-purity silicon substrate, since impurity nuclides are almost excluded, the radiation of the target cooling plate 22 and the contamination to the target raw material 21 can be reduced. Since silicon is highly biocompatible, when radionuclides are used for pharmaceutical applications, safety and quality can be ensured.

According to such radionuclide production system 1, since the target raw material 21 containing the raw material nuclide is implemented on the target cooling plate 22, it is difficult for the radionuclide to be affected by the moldability of the target raw material 21 or the thermal conductivity of the target raw material 21 compared to when the target raw material itself is molded into a target shape. Regardless of the chemical form, moldability, and thermal conductivity of the target raw material 21, the heat load by the irradiation of the particle beams can be efficiently removed, thus restrictions on the design of the device and the selection of the raw material is reduced. Since the target cooling plate 22 acts as a barrier to prevent impurity nuclides from entering the target raw material 21 compared to when the target raw material itself is disposed in the irradiation field alone, the incorporation of external impurity nuclides is prevented. The handling of positioning, transportation, sealing, and the like of the target 20 becomes easy. Accordingly, the cooling ability of the target material containing the raw material nuclide can be improved, and the contamination to the target raw material can be prevented to efficiently produce the desired radionuclide.

### Second Embodiment

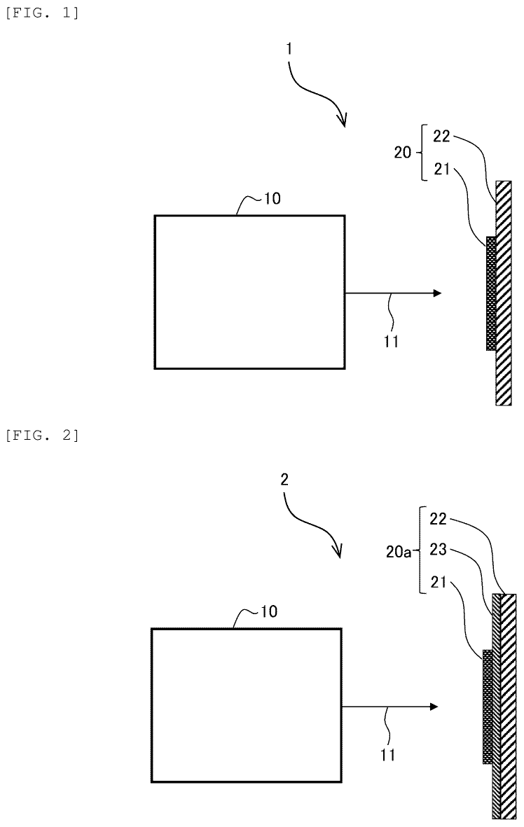

FIG. 2 is a diagram illustrating a configuration example of a radionuclide production system according to a second embodiment.

As illustrated in FIG. 2, a radionuclide production system 2 according to the second embodiment includes the particle beam irradiation device 10 that generates particle beams and a target 20a that generates radionuclides by irradiation of particle beams, similar to the radionuclide production system 1 described above.

The radionuclide production system 2 according to the present embodiment differs from the radionuclide production system 1 in that an oxide film 23 is formed on a front surface of the target cooling plate 22. Other configurations of the radionuclide production system 2 are similar to the radionuclide production system 1 described above.

In the radionuclide production system 2, the target 20a includes the target raw material 21 containing a raw material nuclide that generates radionuclides, the target cooling plate 22 that cools the target raw material 21, and the oxide film 23 that covers the target cooling plate 22.

The oxide film 23 is formed in a film shape by inorganic oxides. The inorganic oxide has excellent thermal and chemical stability. The oxide film 23 acts as a barrier layer that protects the target cooling plate 22 from thermal, physical and chemical actions, and acts as a barrier to prevent impurity nuclides from entering the target raw material 21.

Since the target cooling plate 22 becomes hot due to the heat load by the irradiation of the particle beam 11, there is a risk of deterioration due to thermal oxidation, blistering, and the like. With the oxide film 23, such degradation of the target cooling plate 22 can be prevented. During the separation and refinement process, chemicals such as nitric acid solution are used to dissolve the target raw material 21. With the oxide film 23, degradation of the target cooling plate 22 by such chemicals can be prevented.

The oxide film 23 also acts as a barrier to prevent impurity nuclides from entering the target raw material 21. Due to particle beams, secondary radiation, and the like, impurity nuclides may occur in the irradiation field in which the particle beam 11 is irradiated. Impurities may be scattered or chemicals containing impurities may be used in the separation and refinement field that separates and refines the radionuclide. With the oxide film 23, since such impurity nuclides that try to enter from the outside are trapped in the oxide crystal, contamination to the target raw material 21 can be reduced.

The oxide film 23 can be formed by inorganic oxides such as silicon dioxide, aluminum oxide, and the like. Generally, the inorganic oxide is a material having excellent thermal and chemical stability and low thermal conductivity. Therefore, when the oxide film 23 is provided between the target raw material 21 and the target cooling plate 22, it is preferable to provide the oxide film 23 with a small film thickness not to damage the cooling efficiency of the target raw material 21.

As a method of forming the oxide film 23, a thermal oxidation method, a physical vapor deposition (PVD) method, a chemical vapor deposition (CVD) method, a coating method, and the like can be used. PVD includes a vacuum deposition method, a sputtering method, and the like. CVD includes a thermal CVD method, a plasma CVD method, and the like. The coating method includes a method of applying raw materials and drying and firing the applied raw materials.

The oxide film 23 can be formed of silicon dioxide by thermal oxidation of the target cooling plate 22 when the target cooling plate 22 is made of silicon. From the viewpoint of preventing the deterioration of the target cooling plate 22 itself and the contamination of the target raw material 21, silicon dioxide is preferably provided in a solid structure having low impurities and high filling density.

The oxide film 23 can be formed of aluminum oxide by thermal oxidation of the target cooling plate 22 when the target cooling plate 22 is made of aluminum or aluminum nitride. From the viewpoint of preventing the deterioration of the target cooling plate 22 itself and the contamination of the target raw material 21, aluminum oxide is preferably provided in a solid structure having low impurities and high filling density.

The oxide film 23 may be formed on a part of a front surface of the target cooling plate 22 or may be formed on the entire surface of the target cooling plate 22. However, the oxide film 23 is preferably formed at least on the front surface on which the target raw material 21 is implemented, more preferably on both the front surface on which the target raw material 21 is implemented and the back surface, and more preferably on all surfaces of the target cooling plate 22.

When the oxide film 23 is formed on the front surface on which the target raw material 21 is implemented, the function as a barrier to prevent impurity nuclides from entering the target raw material 21 can be effectively performed. Contamination from at least one direction can be greatly reduced during both the irradiation process and the separation and refinement process. When the oxide film 23 is formed on all surfaces of the target cooling plate 22, not only the function as a barrier can be improved, but also the protection of the target cooling plate 22 during separation and refinement can be improved.

The oxide film 23 may be formed on a front surface of the target raw material 21 in addition to the front surface of the target cooling plate 22. The oxide film 23 can also be formed to cover the target raw material 21 implemented on the target cooling plate 22. When the target raw material 21 is covered with the oxide film 23, it is possible to prevent the contamination of the target raw material 21 and also prevent the scattering of the target raw material 21 and the release of radioactive materials from the target raw material 21.

According to such radionuclide production system 2, in addition to the same effect as the radionuclide production system 1 described above, as the oxide film 23 is formed on the front surface of the target cooling plate 22 on which the target raw material 21 is implemented, an effect of preventing degradation of the target cooling plate 22 by irradiation of the particle beam 11 and degradation of the target cooling plate 22 by the chemical used in the separation and refinement process can be obtained. Since impurity nuclides that try to enter the target raw material 21 from the outside are trapped in the oxide crystal containing oxygen atoms during irradiation of the particle beam 11 and separation and refinement of the radionuclide, contamination to the target raw material 21 can be further prevented.

### Third Embodiment

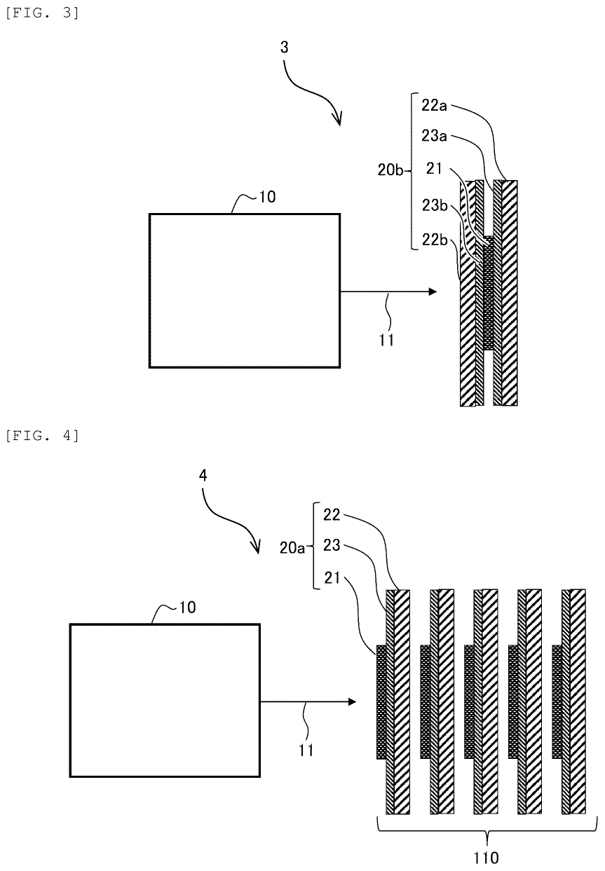

FIG. 3 is a diagram illustrating a configuration example of a radionuclide production system according to a third embodiment.

As illustrated in FIG. 3, a radionuclide production system 3 according to the third embodiment includes the particle beam irradiation device 10 that generates particle beams and a target 20b that generates radionuclides by irradiation of particle beams, similar to the radionuclide production system 1 described above.

The radionuclide production system 3 according to the present embodiment differs from the radionuclide production system 2 in that the target cooling plate 22 is disposed to interpose the target raw material 21 on both sides of the target raw material 21. Other configurations of the radionuclide production system 3 are similar to the radionuclide production system 2 described above.

In the radionuclide production system 3, the target 20b includes the target raw material 21 containing a raw material nuclide that generates radionuclides, a plurality of target cooling plates 22a and 22b that cool the target raw material 21, and a plurality of oxide films 23a and 23b that cover the target cooling plate 22.

The plurality of target cooling plates 22a and 22b are disposed to face each other. The target raw material 21 is implemented between the pair of target cooling plates 22a and 22b. The target raw material 21 is disposed to be interposed between the pair of oxide films 23a and 23b formed on a front surface of each target cooling plate 22a and 22b.

The target raw material 21 is preferably implemented on a surface of a main surface of each of the target cooling plates 22a and 22b for each of the pair of target cooling plates 22a and 22b. The pair of target cooling plates 22a and 22b and the pair of oxide films 23a and 23b may be formed of the same material or different materials from each other.

The arrangement method for disposing the target cooling plates 22a and 22b to face each other is not particularly limited. As an arrangement method, a method of fixing the pair of target cooling plates 22a and 22b to the holding mechanism to interpose the target raw material 21, a method of joining the pair of target cooling plates 22a and 22b to each other using a joining part such as a bolt, a method of crimping each other and bonding by intermolecular force, or the like can be used.

Between the pair of target cooling plates 22a and 22b, a sealing material or the like that seals the target raw material 21 may be attached, or the sealing material or the like may not be attached. Either or both of the pair of target cooling plates 22a and 22b may be provided with a recess for sealing and storing the target raw material 21 or may not be provided with a recess for sealing and storing the target raw material 21.

The target raw material 21 can also be provided to be sealed in a sealing structure by adhering the oxide films 23a and 23b to each other between the pair of target cooling plates 22a and 22b. When the target raw material 21 is provided in a sealed structure, it is possible to prevent the scattering of the target raw material 21 and the release of radioactive materials from the target raw material 21. As a result, the handling of transportation and the like of the target 20b becomes easy.

In FIG. 3, the oxide films 23a and 23b are formed on the front surfaces of the pair of target cooling plates 22a and 22b, respectively, but one of the oxide films 23a and 23b may not be formed, or both of the oxide films 23a and 23b may not be formed. Even if the oxide films 23a and 23b are not formed, the function as a barrier can be obtained by the target cooling plates 22a and 22b.

According to such radionuclide production system 3, in addition to the same effect as the radionuclide production system 1 described above, as the target raw material 21 is implemented between the target cooling plates 22a and 22b, the heat load on the target raw material 21 by irradiation of the particle beam 11 or the like can be efficiently removed from both sides. Since impurity nuclides that try to enter the target raw material 21 from the outside are trapped on the target cooling plates 22a and 22b disposed on both sides during irradiation of the particle beam 11 and during separation and refinement of the radionuclide, contamination to the target raw material 21 can be prevented more widely. Since the oxide film 23 can easily form a sealed structure covering the target raw material 21, the contamination of the target raw material 21, the scattering of the target raw material 21, and the release of radioactive materials from the target raw material 21 can be easily prevented. It is possible to handle the target 20 safely and easily by preventing leakage while ensuring the purity of the radioactive material.

### Fourth Embodiment

FIG. 4 is a diagram illustrating a configuration example of a radionuclide production system according to a fourth embodiment.

As illustrated in FIG. 4, a radionuclide production system 4 according to the fourth embodiment includes the particle beam irradiation device 10 that generates particle beams and the target 20a that generates radionuclides by irradiation of particle beams, similar to the radionuclide production system 2 described above.

The radionuclide production system 4 according to the present embodiment differs from the radionuclide production system 2 in that a plurality of targets 20a are configured to receive the irradiation process of the particle beam 11 simultaneously. Other configurations of the radionuclide production system 4 are similar to the radionuclide production system 2 described above.

In the radionuclide production system 4, the target 20a includes the target raw material 21 containing a raw material nuclide that generates radionuclides, the target cooling plate 22 that cools the target raw material 21, and the oxide film 23 that covers the target cooling plate 22.

The plurality of targets 20a configure a target group 110 that collectively receives the irradiation process of the particle beam 11. The plurality of targets 20a configuring the target group 110 are stacked and positioned with the target cooling plate 22 interposed therebetween along the incident direction of the particle beam 11 when the particle beam 11 is irradiated. The targets 20a configuring the target group 110 can also be provided in a container structure that seals the target raw material 21, respectively.

In FIG. 4, the target group 110 is configured of five targets 20a, but the target group 110 can be configured of random number of targets 20a. Instead of the target 20a on which the oxide film 23 is formed, the target 20 on which the oxide film 23 is not formed, or the target 20b in which the target cooling plate 22 is disposed on both sides of the target raw material 21 can be used.

The plurality of targets 20a configuring the target group 110 may be the same or different from each other in a holding amount of the raw material nuclide. The plurality of targets 20a configuring the target group 110 may be provided at the same thickness as each other or may be provided at different thicknesses from each other. The plurality of targets 20a configuring the target group 110 may be provided at the same size as each other or may be provided at different sizes from each other.

While the particle beam 11 such as an electron beam has a low transmittance, the bremsstrahlung is a radiation with a high transmittance. When the particle beam 11 is used to induce a nuclear reaction, the particle beam 11 such as an electron beam is easily shielded by a structure on the front side. In contrast, when the bremsstrahlung is used to induce the nuclear reaction, the bremsstrahlung emitted by the converter can be irradiated to the plurality of targets 20a configuring the target group 110 while transmitting the target 20a.

For example, when radium 226 (Ra-226) is used as the raw material nuclide, Ra-226 can also serve as the converter. When the electron beam irradiated from the electron linear accelerator is incident on the target raw material 21 containing Ra-226, the bremsstrahlung is emitted by the bremsstrahlung of Ra-226. The bremsstrahlung is irradiated to the surrounding Ra-226 and to the Ra-226 held by the target 20a on the rear side. Ra-226 undergoes a photonuclear reaction of Ra-226 (Y, n) Ra-225 when irradiated with the bremsstrahlung, releasing neutrons to be nuclear transformed to Ra-225. Ra-225 undergoes β decay with a half-life of 14.9 days, resulting in Ac-225. Ac-225 can be recovered by subjecting the target raw material 21 to a separation and refinement process after irradiation.

The desired radionuclides are generated in as large quantities as the targets 20a disposed on the front side among the targets 20a configuring the target group 110. Accordingly, among the plurality of targets 20a configuring the target group 110, a part of the targets 20a where a large amount of radionuclides were generated can be extracted and subjected to the separation and refinement process. The remaining targets 20a can be subjected to the irradiation process continuously. The next and subsequent irradiation processes can be performed in parallel with the separation and refinement process.

A transport mechanism for transporting the target 20a individually can be provided in the radionuclide production system 4. The irradiated target 20a can be transported from the irradiation field to the separation and refinement field by the transport mechanism and subjected to the separation and refinement process. The target 20a subjected to the separation and refinement process can be transported from the separation and refinement field to the irradiation field by the transport mechanism, incorporated into the target group 110, and subjected to the irradiation process after implementing the target raw material 21 again as necessary.

The targets 20a configuring the target group 110 can be arranged at an appropriate distribution ratio for every irradiation process and separation and refinement process. The distribution ratio of the target 20a in the irradiation process and the separation and refinement process can be selected according to the desired supply time of the radionuclide, the desired supply amount of the radionuclide, the stability of the raw material nuclide and the generated nuclide, and the like.

The number of targets 20a distributed in the irradiation process and the number of targets 20a distributed in the separation and refinement process are not particularly limited as long as the number of targets 20a is equal to or greater than one. The number of targets 20a distributed in the irradiation process is preferably greater than the number of targets 20a distributed in the separation and refinement process. The total number of the targets 20a distributed in the irradiation process and the targets 20a distributed in the separation and refinement process is preferably equal to or smaller than 10.

Generally, the time required for the separation and refinement process is difficult to depend on the separation and refinement amount of the radionuclide and is longer than the time required for the irradiation process. When the number of targets 20a distributed in the irradiation process is greater than the number of targets 20a distributed in the separation and refinement process, the amount of radionuclides generated by the irradiation process can be increased while continuously ensuring a predetermined separation and refinement amount.

For the separation and refinement process, it is preferable to transfer a part of targets 20a that have a high amount of radionuclides generated by the nuclear reaction among the targets 20a subjected to the irradiation process. For example, the frontmost target 20a disposed on the incident side in the irradiation direction of the particle beam 11 and the plurality of targets 20a disposed on the incident side can be transported from the irradiation field to the separation and refinement field.

According to such radionuclide production system 4, in addition to the same effect as the radionuclide production system 1 described above, as a plurality of targets 20a configuring the target group 110 receive the irradiation process collectively, the amount of the raw material nuclide that is subjected to a single irradiation process can be increased. When the bremsstrahlung with high transmittance is used, the radiation required for the nuclear reaction can be efficiently irradiated against the multi-stage stacked target raw material 21. Since the amount of radionuclides generated by a single irradiation process is also increased, a large number of radionuclides can be produced efficiently.

With the radionuclide production system 4, among the targets 20a configuring the target group 110, a part of the targets 20a can be subjected to the irradiation process, while the remaining targets 20a can be subjected to the separation and refinement process. The irradiation process and the separation and refinement process can be performed in parallel simultaneously.

As in the related art, when the production of radionuclides is performed using a single target device, it is necessary to perform a series-type production process in which the irradiation process and the separation and refinement process are performed on a single target device sequentially. In a system, there is a problem that it is difficult to stably supply the desired radionuclide at any time. When a single target device is used, the timing of recovering the desired radionuclide by the separation and refinement process is limited.

Generally, the separation and refinement process takes time because a plurality of steps are required. The desired radionuclide may be reduced by radioactive decay after being generated by the irradiation process. After nuclear transformation from the raw material nuclide to the daughter nuclide, the radionuclide may be produced to radioactive decay the daughter nuclide into the progeny nuclide. When radioactive decay is used, it takes time to generate the progeny nuclide after the irradiation process. When a single target device is used, the execution time of the separation and refinement process must be increased to recover the desired radionuclide at any time.

However, increasing the execution time of the separation and refinement process results in a longer period of time for the target device to be subjected to the separation and refinement process, and thus a period of time for the target device to be subjected to the irradiation process is shortened. When series-type production process is performed, the irradiation process needs to be stopped during the separation and refinement process. When the irradiation process period is shortened, the amount of radionuclides produced by nuclear reactions will be limited. In other words, when a single target device is used, the relationship between the production amount and the recovery frequency of the radionuclide is a trade-off.

In contrast, using the target group 110 configured of a plurality of targets 20a makes it possible to ensure a sufficient amount of production and provide on-demand supply with little excess or deficiency of the desired radionuclide. Since a part of targets 20a among the plurality of targets 20a configuring the target group 110 can be subjected to the separation and refinement process to recover the desired radionuclide, the frequency of recovery of the desired radionuclide can be increased, and any amount of radionuclide can be supplied to the consumer at any time. Meanwhile, since the remaining targets 20a can be subjected to the irradiation process, amount of desired radionuclide produced by the nuclear reaction can be maximized.

Although embodiments of the present invention have been described above, the present invention is not limited to the above-described embodiments, and various changes can be made within the scope without departing from the spirit of the present invention. For example, the present invention is not necessarily limited to those including all the configurations provided in the above-described embodiments. A part of the configuration of one embodiment can be replaced with another, a part of the configuration of one embodiment can be added to another, or a part of the configuration of one embodiment can be omitted.

### REFERENCE SIGNS LIST

1, 2, 3, 4: radionuclide production system
10: particle beam irradiation device
20, 20a, 20b: target
21: target raw material
22, 22a, 22b: target cooling plate
23, 23a, 23b: oxide film
110: target group

1. A radionuclide production system that generates radionuclides, the system comprising:
a particle beam irradiation device that generates particle beams; and
a target that generates radionuclides by irradiation of the particle beams, wherein
in the target, a target raw material containing a raw material nuclide that generates the radionuclide is implemented on a target cooling plate that cools the target raw material.

2. The radionuclide production system according to claim 1, wherein
the target cooling plate is formed of a material having a higher thermal conductivity than the target raw material.

3. The radionuclide production system according to claim 1, wherein
the target cooling plate is made of silicon, silicon dioxide, silicon carbide, aluminum, aluminum nitride, or diamond.

4. The radionuclide production system according to claim 1, wherein
an oxide film is formed on a front surface of the target cooling plate.

5. The radionuclide production system according to claim 1, wherein
the oxide film is formed of silicon dioxide or aluminum oxide.

6. The radionuclide production system according to claim 1, wherein
the raw material nuclide is radium 226 (Ra-226).

7. The radionuclide production system according to claim 1, wherein
a nuclide containing actinium 225 (Ac-225) is generated as the radionuclide.

8. The radionuclide production system according to claim 1, wherein
the particle beam irradiation device is an electron linear accelerator and irradiates electron beams as the particle beams.

9. The radionuclide production system according to claim 1, wherein
the number of the target is plural, and when the particle beams are irradiated, a plurality of the targets are stacked with the target cooling plate interposed therebetween.

10. A radionuclide production method that radionuclides, the method comprising:
forming a target in which a target raw material containing a raw material nuclide that generates radionuclides by irradiation of particle beams is implemented on a target cooling plate that cools the target raw material, and producing radionuclides by irradiating the target with particle beams or bremsstrahlung while cooling the target raw material by the target cooling plate.
